(19) United States
(12) Patent Application Publication
(10) Pub. No.: US 2013/0269490 A1
(43) Pub. Date: Oct. 17, 2013

(54) Wrench

(71) Applicant: KABO TOOL COMPANY, Taichung (TW)

(72) Inventor: Chih-Ching HSIEH, Taichung City (TW)

(73) Assignee: KABO TOOL COMPANY, Taichung City (TW)

(21) Appl. No.: 13/716,198

(22) Filed: Dec. 16, 2012

(30) Foreign Application Priority Data
Apr. 13, 2012 (TW) 101113281

(51) Int. Cl. B25B 23/00

(52) U.S. Cl. CPC B25B 23/0007
USPC 81/125.1

(57) ABSTRACT

A wrench includes a handle, a first driver, and a second driver. The first driver and the second driver are integrally connected to two ends of the handle respectively. An angle between a driving axis of the first driver and a central axis of the handle is α, an angle between one opening end of the first driver and the handle is φ, an angle between a driving axis of the second driver and the central axis of the handle is β, and an angle between one opening end of the second driver and the handle is θ. The angle α and the angle β are located at two sides of the central axis of the handle respectively. The other opening end of the first driver and the other opening end of the second driver are horizontally connected to the handle respectively.

### RELATED APPLICATIONS

The application claims priority to Taiwan Application Serial Number 10113281, filed Apr. 13, 2012, which is herein incorporated by reference.

### BACKGROUND

1. Field of Invention

The present disclosure relates to a hand tool. More particularly, the to present disclosure relates to a wrench.

2. Description of Related Art

A conventional wrench has a main body and two drive portions extending horizontally from two ends of the main body respectively. When the conventional wrench is operated for applying to a workpiece assembled at a device with an uneven surface, it is hard to operate the workpiece rigidly by the conventional wrench, or the operating angle or the applicable range of the conventional wrench would be confined. Furthermore, the user is unable to hold the conventional wrench comfortably and is likely to be injured due to the improper holding gesture during the operation.

### SUMMARY

According to one aspect of the present disclosure, a wrench includes a handle, a first driver, and a second driver. The first driver is integrally connected to an end of the handle and the second driver is integrally connected to the other end of the handle. An angle between a driving axis of the first driver and a central axis of the handle is α and an angle between one opening end of the first driver and the handle is φ. An angle between a driving axis of the second driver and the central axis of the handle is β and an angle between one opening end of the second driver and the handle is θ. The angle α and the angle β are located at two sides of the central axis of the handle respectively. The other opening end of the first driver is horizontally connected to the handle. The other opening end of the second driver is horizontally connected to the handle. The second driver is hollow tube-shaped and has a plurality of teeth.

### BRIEF DESCRIPTION OF THE DRAWINGS

The disclosure can be more fully understood by reading the following detailed description of the embodiment, with reference made to the accompanying drawings as follows:

FIG. 1 is a three dimensional view of a wrench according to one embodiment of the present disclosure;

FIG. 2 is a front view of the wrench of FIG. 1;

FIG. 3 is a side view of the wrench of FIG. 1; and

FIG. 4 is a partial sectional view of the wrench of FIG. 1.

### DETAILED DESCRIPTION

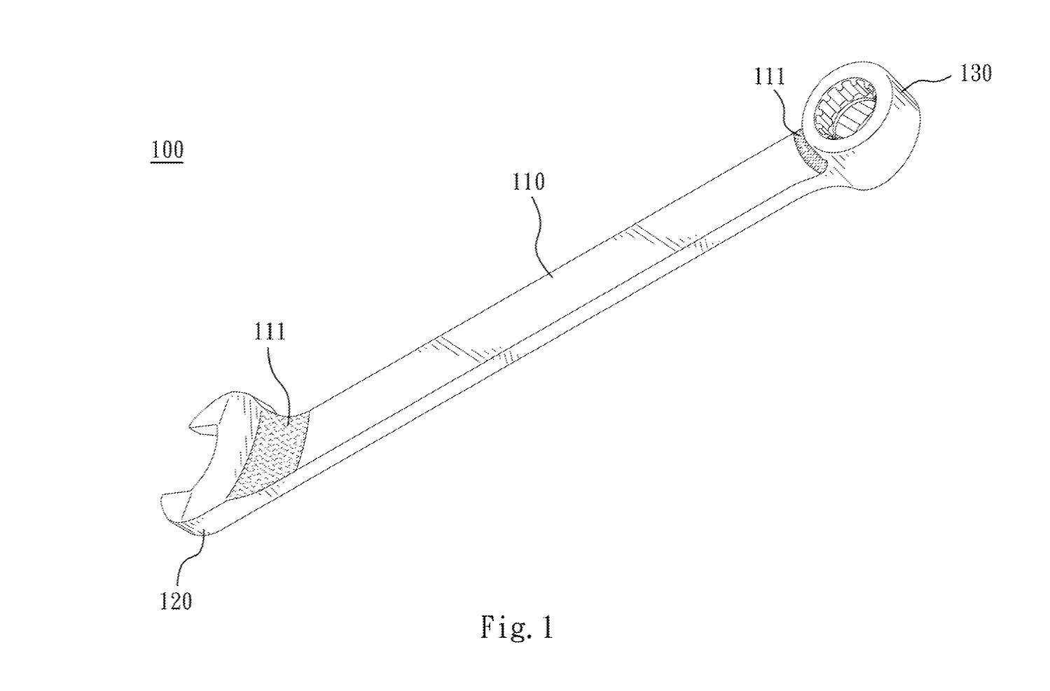

FIG. 1 is a three dimensional view of a wrench according to one embodiment of the present disclosure. In FIG. 1, the wrench 100 includes a handle 110, a first driver 120, and a second driver 130. The first driver 120 and the second driver 130 are integrally connected to two ends of the handle 110 respectively. The two ends of the handle 110 have an embossed portion 111 disposed that prevents hand slipped. Be noted that the embossed portion 111 may only disposed at one of the two ends of the handle 110.

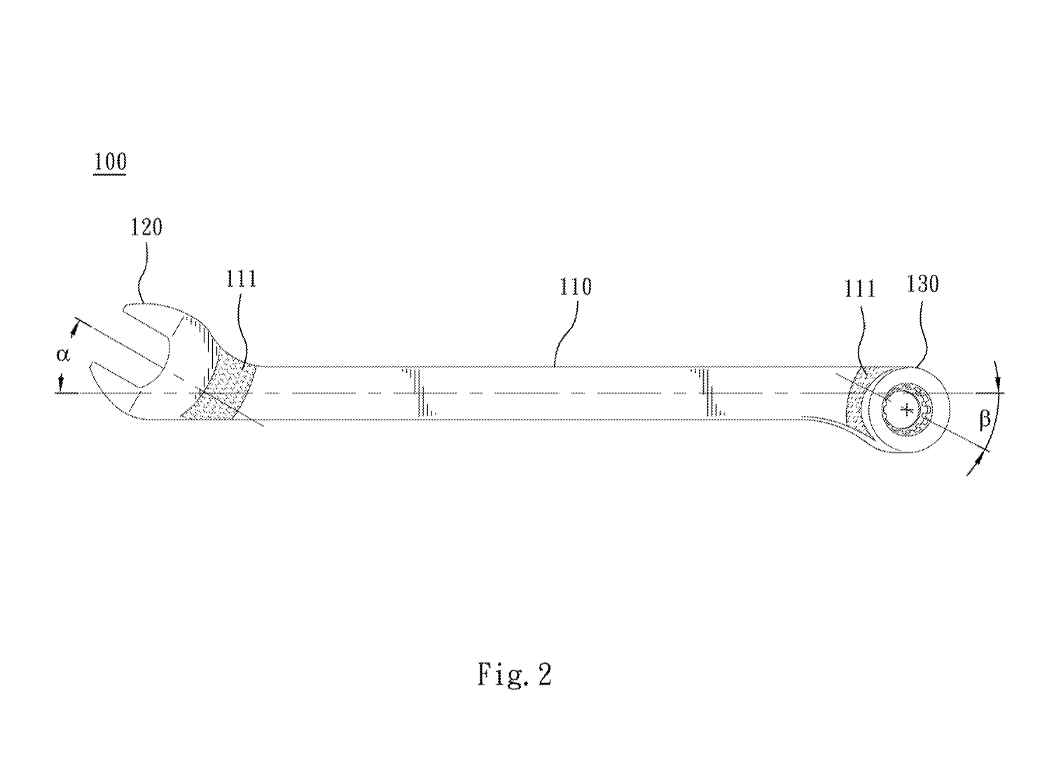

FIG. 2 is a front view of the wrench of FIG. 1. In FIG. 2, an angle α is formed between a driving axis of the first driver 120 and a central axis of the handle 110, wherein 7 degrees<α<45 degrees. An angle β is formed between a driving axis of the second driver 130 and the central axis of the handle 110, wherein 7 degrees<β<45 degrees. Specifically, the angle α and the angle β are located at two sides of the central axis of the handle 110 respectively. Both the driving axis of the first driver 120 and the driving axis of the second driver 130 deviate from the central axis of the handle 110, wherein the angle α and the angle β are on the two sides of the central axis of the handle 110 respectively, thereby enabling the operation of the wrench 100 to be labor-saving and the holding of the wrench 100 to be convenient and comfortable.

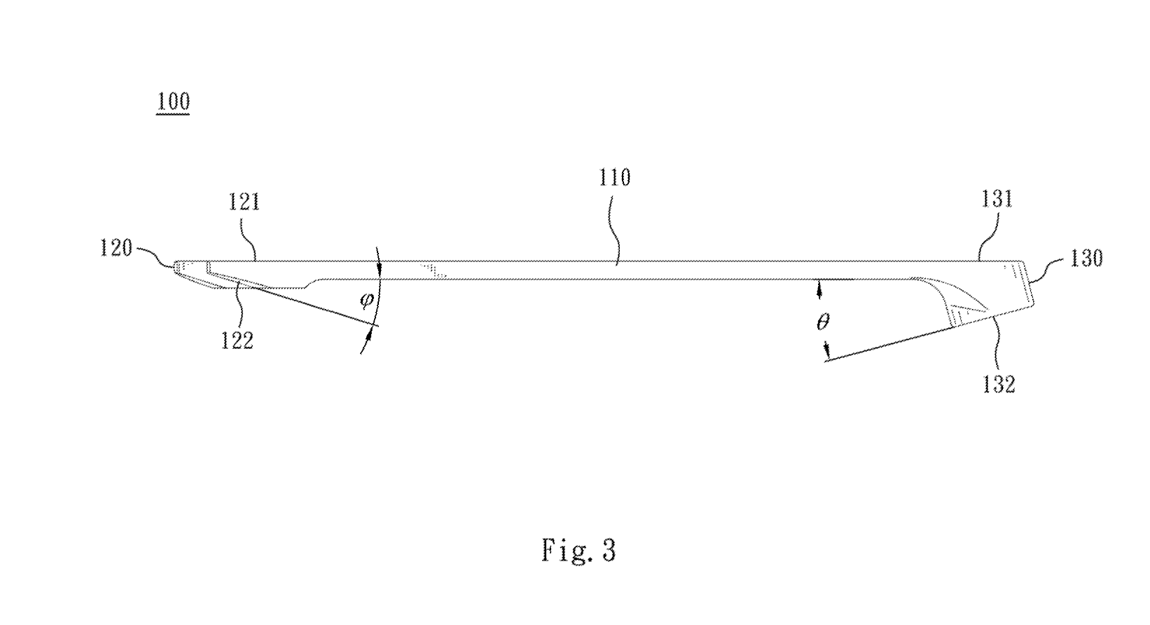

FIG. 3 is a side view of the wrench of FIG. 1. In FIG. 3, an angle φ is formed between one opening end 122 of the first driver 120 and the handle 110, wherein 0 degrees<φ<25 degrees. An angle θ is formed between one opening, end 132 of the second driver 130 and the handle 110, wherein 0 degrees<θ<25 degrees. Thus, the wrench 100 can be adapted to a workpiece assembled at a device with an uneven surface or located adjacent to an obstruction of a device. The angle φ and the angle θ also make the wrench 100 easy to hold and the user can change the holding manner as needed during operation. On the other hand, the other opening end 121 of the first driver 120 and the other opening end 131 of the second driver 130 are horizontally connected to the handle 110 respectively. Thus, the wrench 100 can fit a flat edge of a device and both the first driver 120 and the second driver 130 can rigidly contact a workpiece on the device that make the operation of the wrench 100 smoother.

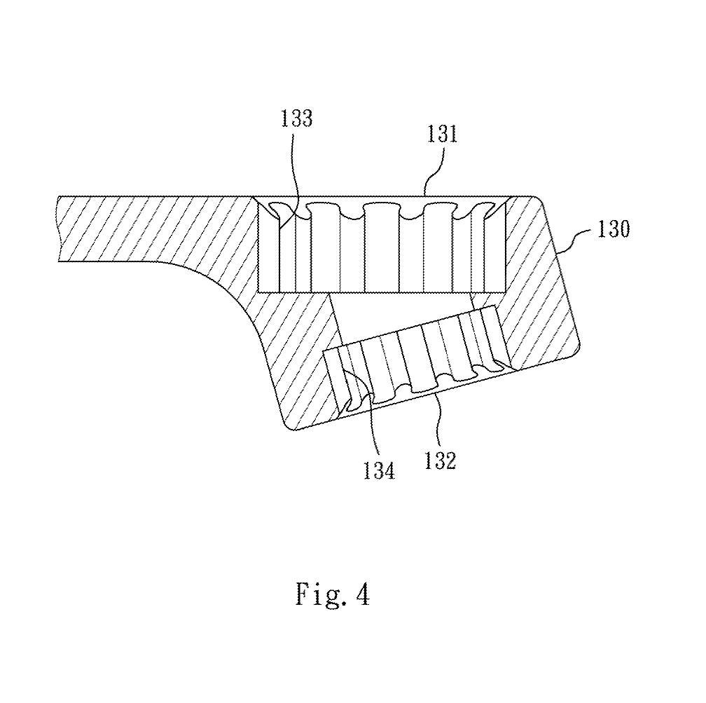

FIG. 4 is a partial sectional view of the wrench of FIG. 1. In FIG. 4, the second driver 130 is hallo tube-shaped and has a plurality of teeth. The teeth include a first teeth portion 133 and a second teeth portion 134. The first teeth portion 133 is perpendicular to the opening end 131 of the second driver 130, and the second teeth portion 134 is perpendicular to the opening end 132 of the second driver 130.

As described above, the present disclosure has the following advantages:

1. The angles facilitate the holding of the wrench 100 and make the operation of the wrench 100 labor-saving.

2. The opening end 121 of the first driver 120 and the opening end 131 of the second driver 130 are horizontally connected to the handle 110 respectively that make the operation of the wrench 100 smoother.

3. The embossed portion 111 disposed at the handle 110 prevents hand slipped.

Although the present disclosure has been described in considerable detail with reference to certain embodiment thereof, other embodiments are possible, Therefore, their spirit and scope of the appended claims should no be limited to the description of the embodiment container herein.

It will be apparent to those skilled in the art that various modifications and variations can be made to the structure of the present disclosure without departing from the scope or spirit of the invention. In view of the foregoing, it is intended that the present disclosure cover modifications and variations of this invention provided they fall within the scope of the following claims.

What is claimed is:

1. A wrench, comprising:
a handle;
a first driver integrally connected to an end of the handle, wherein an angle between a driving axis of the first driver and a central axis of the handle is α, an angle between one opening end of the first driver and the handle is φ, and the other opening end of the first driver is horizontally connected to the handle; and
a second driver being hollow tube-shaped integrally connected to the other end of the handle, and having a plurality of teeth, wherein an angle between a driving axis of the second driver and the central axis of the handle is β, an angle between one opening end of the second driver and the handle is θ, the other opening end of the second driver is horizontally connected to the handle, and α and β are located at two sides of the central axis of the handle respectively.

2. The wrench of claim 1, wherein the handle has a uniform thickness form center to two ends.

3. The wrench of claim 1, wherein 7 degrees<α<45 degrees.

4. The wrench of claim 1, wherein 7 degrees<β<45 degrees.

5. The wrench of claim 1, wherein 0 degree <θ<25 degrees.

6. The wrench of claim 1, wherein 0 degree 21 φ<25 degrees.
